(19) United States
(12) Patent Application Publication
(10) Pub. No.: US 2018/0230861 A1
(43) Pub. Date: Aug. 16, 2018

(54) METHOD AND DEVICE FOR ASSEMBLING AN ADJUSTABLE CAMSHAFT

(71) Applicants: THYSSENKRUPP PRESTA TECCENTER AG, Eschen (LI); THYSSENKRUPP AG, Essen (DE)

(72) Inventors: Reinhard SCHLEMMER, Hohenems (AT); Marko CURLIC, Schaanwald (LI); Aaron PFITSCHER, Ludesch (AT)

(73) Assignees: THYSSENKRUPP PRESTA TECCENTER AG, Eschen (LI); THYSSENKRUPP AG, Essen (DE)

(21) Appl. No.: 15/751,912

(22) PCT Filed: Jul. 29, 2016
(86) PCT No.: PCT/EP2016/068161

§ 371 Date: Feb. 12, 2018

(30) Foreign Application Priority Data
Aug. 11, 2015 (DE) 10 2015 215 292.8

(51) Int. Cl. F01L 1/047; B21D 53/84; B23P 19/10

(52) U.S. Cl. CPC F01L 1/047; B21D 53/845; B23P 2700/02; F01L 2001/0473; B23P 19/10

(57) ABSTRACT

A method and a device may be used to assemble an adjustable camshaft that includes a shaft segment with an inner shaft that extends concentrically through a through-hole of an outer shaft. The method may involve prepositioning the inner shaft by at least partially introducing the inner shaft eccentrically into the through-hole of the outer shaft. The method may further involve introducing a positioning element in an introduction direction through a first outer shaft hole formed in a peripheral wall of the outer shaft, through an inner shaft hole that extends orthogonally to a longitudinal axis of the inner shaft, and through a second outer shaft hole formed in a peripheral wall of the outer shaft such that the positioning element projects out of the second outer shaft hole. Further, the inner shaft may be finally positioned, wherein the positioning element is moved counter to the introduction direction such that the inner shaft is orientated concentrically inside the through-hole of the outer shaft.

The present invention relates to a method and a device for assembling an adjustable camshaft which comprises at least one shaft segment having an outer shaft and an inner shaft which extends concentrically through a through-hole of the outer shaft.

An adjustable camshaft is known, for example, from DE 20 2005 021 715 U1. The adjustable camshaft for the valve drive of an internal combustion engine comprises an outer shaft, on which first cams which are arranged so as to be rotationally secure with respect to this outer shaft are located, and wherein an inner shaft to which second cams are connected in a rotationally secure manner extends through the outer shaft. The second cams are supported on the outer shaft at the outer side. As soon as the inner shaft is rotated relative to the outer shaft with regard to the phase position thereof, the control position of the first cams is displaced relative to the control position of the second cams. The change of the phase position of the inner shaft relative to the phase position of the outer shaft is produced by means of a cam displacement device which is arranged on the camshaft and which can be activated with a compressed oil.

In particular during the assembly of a corresponding adjustable camshaft, there is the difficulty of arranging the adjustable inner shaft concentrically in the through-hole of the outer shaft and in particular to arrange and fix it in such a manner that the maximum play present between the two components, that is to say, the inner shaft and the outer shaft, is of the same size radially. Particularly in the case of an eccentric arrangement of the inner shaft inside the outer shaft, this may lead to occurrences of friction between the outer surface of the inner shaft and the through-hole surface of the outer shaft, wherein a frictionless and therefore operationally reliable rotation or adjustment of the inner shaft about the longitudinal center axis thereof also cannot be ensured.

Therefore, an object of the present invention is to at least partially overcome the above-described disadvantages in a method and a device for assembling an adjustable camshaft. An object of the present invention is in particular to provide a method and a device for assembling an adjustable camshaft which allow in a simple and cost-effective manner a concentric or central arrangement of the inner shaft inside the outer shaft so that jamming or an abutment increasing the friction between the inner shaft and the outer shaft, in particular during the adjustment of the camshaft during operation, is advantageously prevented.

The above object is achieved by a method for assembling an adjustable camshaft having the features according to claim 1 and by a device for assembling an adjustable camshaft having the features according to claim 11. Additional features and details of the invention will be appreciated from the dependent claims, the description and the drawings. In this case, features and details which are described in connection with the method naturally also apply in connection with the device according to the invention and vice versa so that reference is or can be always mutually made to the individual aspects of the invention with respect to the disclosure. Furthermore, the method according to the invention can be carried out with the device according to the invention.

The method for assembling an adjustable camshaft which comprises at least one shaft segment having an outer shaft and an inner shaft which extends concentrically through a through-hole of the outer shaft comprises at least the following steps:
prepositioning the inner shaft, wherein the inner shaft is at least partially introduced eccentrically into the through-hole of the outer shaft,
introducing a positioning element in an introduction direction through a first outer shaft hole which is formed in a peripheral wall of the outer shaft, an inner shaft hole which extends orthogonally to the longitudinal axis of the inner shaft and a second outer shaft hole which is formed in a peripheral wall of the outer shaft in such a manner that the positioning element projects out of the second outer shaft hole,
final positioning of the inner shaft, wherein the positioning element is moved counter to the introduction direction in such a manner that the inner shaft is orientated concentrically inside the through-hole of the outer shaft. The adjustable camshaft advantageously also comprises, in addition to the shaft segment, at least one cam segment having at least one cam path, advantageously also two cam paths. The cam segment is pressed, for example, on the outer shaft so that the outer shaft extends through a corresponding through-hole of the cam segment. However, it is also conceivable for the cam segment to be rotatably arranged on the outer shaft and to be connected to the inner shaft in a rotationally secure manner. In this case, for example, a connection element extends between the inner shaft and the cam segment through a corresponding outer shaft hole. Furthermore, it is also conceivable for the adjustable camshaft to comprise at least two cam segments, in particular one cam segment which is connected to the outer shaft in a rotationally secure manner and one cam segment which is supported in a rotationally secure manner with respect to the inner shaft and rotatably on the outer shaft.

The outer shaft is advantageously a hollow shaft, through which the inner shaft which is advantageously a solid shaft extends. After the assembly of the adjustable camshaft, the inner shaft is concentrically arranged inside the outer shaft according to the invention. This means that the outer shaft and the inner shaft comprise a common central rotation axis (longitudinal axis). During the prepositioning of the inner shaft inside the through-hole of the outer shaft, the inner shaft is introduced into this through-hole and in particular set down inside the through-hole of the outer shaft using gravitational force in such a manner that the inner shaft at least partially contacts an inner surface of the outer shaft, in particular a surface of the through-hole of the outer shaft. Consequently, the inner shaft is introduced eccentrically relative to the outer shaft inside the through-hole of the outer shaft. In order consequently to arrange the inner shaft concentrically relative to the outer shaft, a positioning element is introduced in an introduction direction into the shaft segment. The positioning element is advantageously a pin element which is introduced, for example, through a first outer shaft hole which is formed in a peripheral wall of the outer shaft and which is further introduced into an inner shaft hole of the inner shaft and advantageously pushed out of the shaft segment again, at least slightly, through a second outer shaft hole which is formed in the peripheral wall of the outer shaft. In an advantageous manner, the positioning element projects out of the second outer shaft hole and consequently out of the shaft segment in this region. This means that the positioning element projects out of the shaft segment at the side which is opposite the side of the shaft segment, at which the positioning element was introduced into the shaft segment. Consequently, in the context of the invention the first hole (outer shaft hole or where applicable also fixing element hole) is intended to be understood to be the hole into which the positioning element is introduced into the shaft segment.

Advantageously, the outer shaft holes which are introduced or formed in the peripheral wall of the outer shaft are constructed so as to be in alignment with each other. After the positioning element has been introduced, the final positioning of the inner shaft is advantageously carried out. In this case, consequently, the positioning element is moved counter to the introduction direction in such a manner that the positioning element advantageously slides through the outer shaft hole of the outer shaft (sliding friction). Conversely, however, there is static friction between the positioning element and the inner shaft in such a manner that the inner shaft is moved counter to the introduction direction. Consequently, the inner shaft is lifted off the wall of the through-hole of the outer shaft and is positioned centrally or concentrically inside the through-hole of the outer shaft. This means that the inner shaft is also carried with this positioning element in the case of the positioning element being pushed back and is consequently moved counter to the introduction direction. This is caused by a corresponding static friction force which exists between the inner shaft, in particular the inner shaft hole surface and the positioning element, in particular the outer surface of the positioning element, and which is higher than the sliding friction force which exists between the outer shaft, in particular the outer shaft hole surface and the positioning element, in particular the outer surface of the positioning element.

In the context of the invention, it is conceivable for the positioning element at least to be pushed out of the shaft segment at least by the magnitude of half of the maximum possible play in the introduction direction. The possible play exists between the outer surface of the inner shaft and the surface of the through-hole of the outer shaft. Advantageously, the maximum possible play is produced in the case of free movement of the inner shaft in a radial direction within the through-hole. In the case of a concentric arrangement of the inner shaft inside the through-hole of the outer shaft, half a maximum possible play is available when viewed in a radial direction between the outer surface of the inner shaft and the surface of the through-hole of the outer shaft.

Consequently, it is advantageously conceivable for the positioning element at least to be moved into the shaft segment by less than the magnitude of half of the maximum possible play, by more than the magnitude of half of the maximum possible play or by precisely the magnitude of half of the maximum possible play counter to the introduction direction. Advantageously, the inner shaft is moved together with the positioning element counter to the introduction direction to such an extent that a concentric arrangement of the inner shaft inside the through-hole of the outer shaft is produced. After the positioning element has been moved back or pushed back counter to the introduction direction, it advantageously no longer projects out of the shaft segment. However, it is also conceivable for the positioning element at least to be pushed out of the shaft segment by more than the magnitude of half of the maximum possible play in the introduction direction and at least to be moved into the shaft segment by precisely the magnitude of half of the maximum possible play counter to the introduction direction. Alternatively, it is conceivable for the positioning element at least to be pushed out of the shaft segment by precisely the magnitude of half of the maximum possible play in the introduction direction and at least to be moved into the shaft segment by less than half of the maximum possible play counter to the introduction direction. In these cases, it is possible for the positioning element still to project—at least partially—out of the shaft segment, in particular at the side which is opposite the introduction side. It is also possible for the positioning element at least to be pushed out of the shaft segment, for example, by precisely the magnitude of half of the maximum possible play in the introduction direction and at least to be moved into the shaft segment by more than the magnitude of half of the maximum possible play counter to the introduction direction. It is then possible for the positioning element still to—at least partially—project out of the shaft segment, in particular introduction side. The magnitude of the introduction and withdrawal of the positioning element may advantageously be varied with consideration of the inner shaft which is intended to be positioned and the friction forces between the positioning element and the inner shaft hole surface. Thus, it is conceivable for an additional withdrawal—as an introduction—of the positioning element to be necessary as a result of a sliding action between the surface of the inner shaft hole and the positioning element. Advantageously, however, an introduction of the positioning element is produced by (precisely) the magnitude of half of the maximum possible play in and counter to the introduction direction for the movement of the positioning element out of the shaft segment and into the shaft segment. An additional monitoring with regard to the correct central arrangement of the inner shaft in the outer shaft is therefore advantageously dispensed with.

It is further conceivable for an orientation element to be introduced, before the positioning element is introduced in the introduction direction, at least through the first outer shaft hole and the inner shaft hole at least for the orientation of the first outer shaft hole relative to the inner shaft hole. Advantageously, the orientation element is constructed in a pin-like or rod-like manner. The orientation element is advantageously used to orientate the inner shaft relative to the outer shaft in such a manner that the inner shaft hole is arranged in alignment with at least one outer shaft hole. This advantageously makes it easier to introduce the orientation element into the shaft segment.

It is further possible for the orientation element to be further introduced at least partially into the second outer shaft hole. Consequently, the orientation element is advantageously completely pushed through the shaft segment or pushed into the shaft segment, whereby the orientation of the inner shaft relative to the outer shaft is again optimized.

It is further conceivable for an orientation element, before the positioning element is introduced, to be introduced counter to the introduction direction at least through the second outer shaft hole and the inner shaft hole at least for the orientation of the second outer shaft hole relative to the inner shaft hole. Unlike the previously mentioned alternative, the orientation element is introduced in this case counter to the introduction direction into the shaft segment, wherein the introduction direction substantially corresponds to the direction in which the positioning element is introduced into the shaft segment. Consequently, it is conceivable for the orientation element and the positioning element to be able to be introduced in the same direction into the shaft segment or also in mutually opposite directions into the shaft segment. The introduction of the orientation element counter to the introduction direction is advantageously possible if the tool for assembling the adjustable camshaft allows this. In this case, for example, it is necessary for the shaft segment to be able to be gripped from two mutually opposite sides.

It is further conceivable for the above-mentioned introduction of the orientation element counter to the introduction direction for the orientation element further to be introduced at least partially into the first outer shaft hole. In this case, it is also consequently possible for the orientation element to be introduced into the shaft segment not only partially but advantageously completely.

Furthermore, it is conceivable for the orientation element to be moved counter to the introduction direction out of the shaft segment. It is further also possible for the orientation element to be moved in the introduction direction out of the shaft segment. The above-mentioned variations of the introduction and withdrawal of the orientation element consequently allow the orientation element to be introduced in the same direction as the positioning element into the shaft segment, to be guided through the shaft segment and to be moved out of the shaft segment at the opposite side. It is further also conceivable for the orientation element to be introduced into the shaft segment at the same side as the positioning element, to be guided through the shaft segment and to be guided back again or to be pulled out again in such a manner that the orientation element is pulled out of the shaft segment counter to the introduction direction. It is further also conceivable for the orientation element to be introduced relative to the positioning element in the opposite direction, that is to say, counter to the introduction direction, into the shaft segment, to be guided through the shaft segment and to be moved out of the shaft segment at the opposite side or to be moved out at the same side, relative to the one at which it was introduced into the shaft segment.

In the context of the invention, it is further conceivable for a fixing element to be arranged on the outer shaft in such a manner that at least one fixing element hole which extends through a peripheral wall of the fixing element is arranged in alignment with at least one outer shaft hole. Advantageously, the fixing element is constructed in a tubular or sleeve-like manner and is consequently pushed onto the outer shaft. Advantageously, the fixing element comprises two fixing element holes which are constructed in alignment with each other. It is further conceivable for the outer shaft hole or at least one of the outer shaft holes to have greater dimensions to such an extent that the positioning or centering of the inner shaft within the outer shaft is possible by means of the fixing element and not by means of the outer shaft. To this end, it is conceivable for the outer shaft hole to be constructed, for example, in the form of an elongate hole, through which the positioning element extends. Advantageously, the fixing element accordingly comprises fixing element holes which consequently allow the inner shaft to be positioned by means of the positioning element. This means that there is between the surface of the fixing element hole and the surface of the positioning element a static friction force whose breakaway torque is smaller than in the case of the static friction force which exists between the inner shaft or the inner shaft hole and the surface of the positioning element. A movement of the positioning element through the fixing element holes for carrying the inner shaft and the concentric arrangement thereof inside the outer shaft is thereby advantageously made possible. The fixing element is advantageously a cam segment or a cam element, such as, for example, a collared cam segment, comprising at least one cam path, advantageously also two or more cam paths. It is further conceivable for the fixing element to be a displacement element comprising a guide groove for guiding an actuator pin. Advantageously, the positioning element projects at least at one side out of the outer shaft to such an extent that it becomes possible to connect the positioning element to the fixing element. This means that it is conceivable for the positioning element to project out of the outer shaft at least at the introduction side, advantageously at the introduction side and the side opposite the introduction side. Depending on the extent to which the positioning element has been pushed in the introduction direction through the outer shaft and advantageously also through the fixing element, or pushed out, it is conceivable for the positioning element to project at least at one side of the fixing element when the positioning element is pushed back for the orientation of the inner shaft, in particular to project at the introduction side or at the side opposite the introduction side. It is also conceivable for the positioning element to terminate with the fixing element, in particular the outer surface of the fixing element, in such a manner that it does not project out of the fixing element.

The device for assembling an adjustable camshaft having at least one shaft segment, wherein the shaft segment comprises an outer shaft and an inner shaft which extends concentrically through a through-hole of the outer shaft, comprises at least a first arrangement segment for positioning the inner shaft inside the through-hole of the outer shaft in such a manner that the inner shaft is arranged eccentrically relative to the outer shaft and a second arrangement segment for positioning the inner shaft inside the through-hole of the outer shaft in such a manner that the inner shaft is arranged concentrically relative to the outer shaft. The first arrangement segment and the second arrangement segment comprise according to the invention at least one retention means which at least positions the outer shaft or a fixing element which can be arranged on the outer shaft. According to the invention the first arrangement segment comprises a recess for receiving a portion of a positioning element projecting out of the shaft segment, which positioning element is at least partially introduced through the shaft segment. The second arrangement segment comprises according to the invention a contacting means for introducing the positioning element, advantageously at least by the length of the projecting portion, at least into the shaft segment. However, it is also conceivable for the positioning element to be introduced into the shaft segment by less than the length of the projecting portion. Consequently, the positioning element at least partially projects out of the shaft segment at the side which is opposite the introduction side of the shaft segment. It is also conceivable for the positioning element to be introduced into the shaft segment further than by the length of the projecting portion. Subsequently, it is possible for the positioning element to project out of the shaft segment at the introduction side. The retention means are advantageously recesses which are constructed or geometrically formed in such a manner that they can receive the camshaft at least over a peripheral portion. Projections or retention projections or comparable means are advantageously also used as retention means.

In the device described, there result all the advantages which have already been described in relation to a method for assembling an adjustable camshaft according to the first aspect of the invention.

The method according to the invention and the device according to the invention for assembling an adjustable camshaft are explained in greater detail below with reference to drawings. In the schematic drawings:

FIG. 1 is a cross-section of an embodiment of an adjustable camshaft arranged in an embodiment of a device for assembling the adjustable camshaft in the assembly step of the prepositioning of the inner shaft inside the through-hole of the outer shaft,

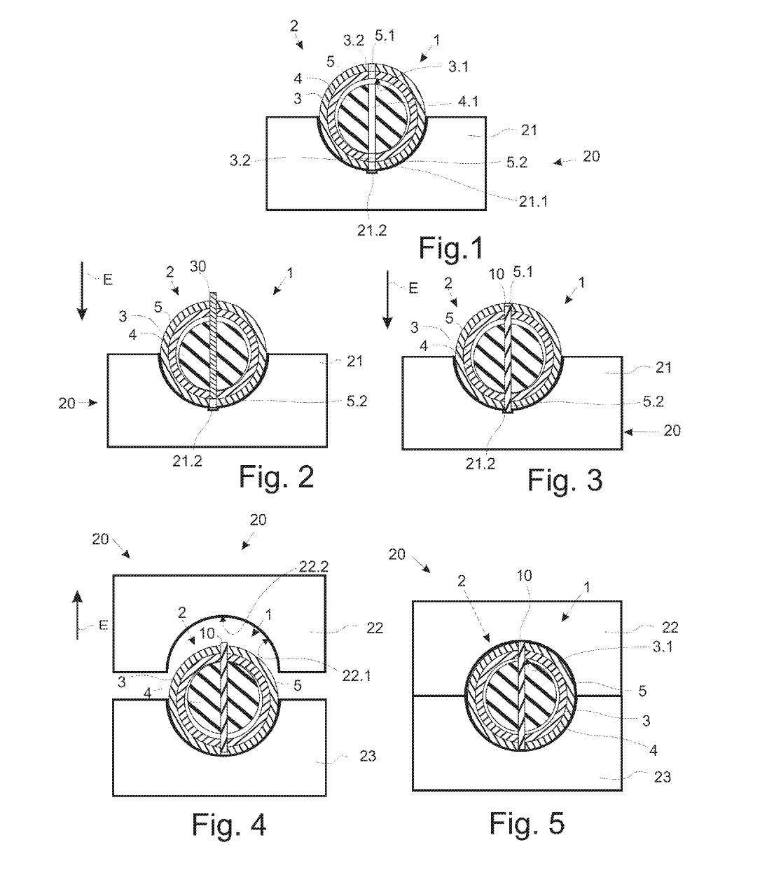

FIG. 2 is a cross-section of the embodiment shown in FIG. 1 of an adjustable camshaft during the introduction of an orientation element,

FIG. 3 is a cross-section of the embodiment of an adjustable camshaft as shown in FIGS. 1 and 2 during the introduction of a positioning element,

FIG. 4 is a cross-section of the embodiment of an adjustable camshaft as shown in FIGS. 1 to 3 during the final positioning of the inner shaft relative to the outer shaft,

FIG. 5 shows the embodiment of an adjustable camshaft as shown in FIGS. 1 to 4 after the assembly has been carried out according to the method according to the invention,

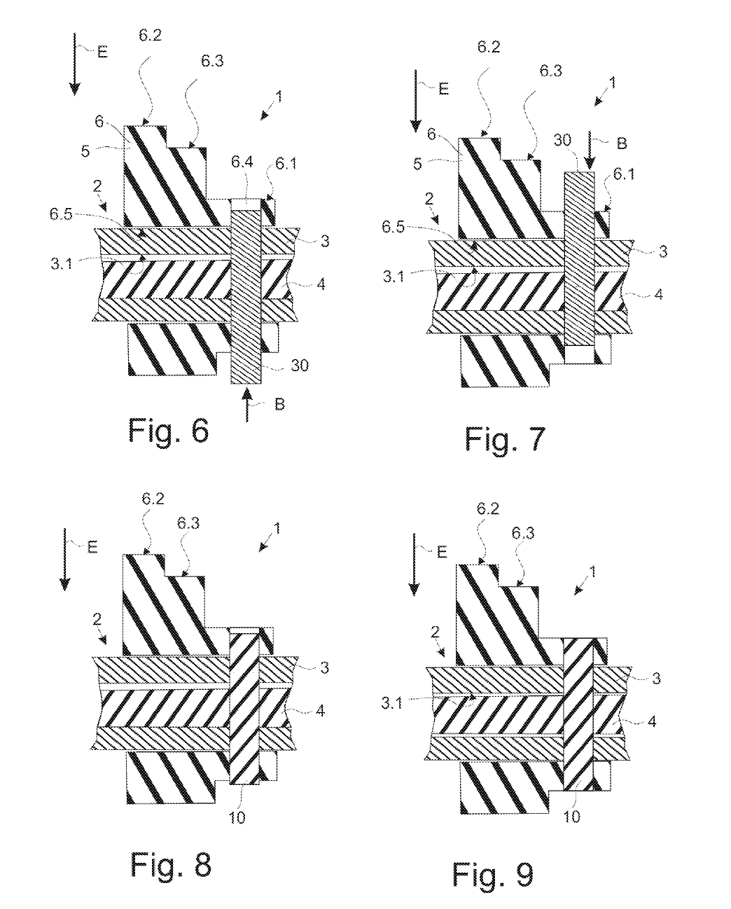

FIG. 6 is a lateral section of a cutout of an additional embodiment of an adjustable camshaft with an orientation element which is introduced counter to the introduction direction,

FIG. 7 is a lateral section of a cutout of the embodiment shown in FIG. 6 of an adjustable camshaft with an orientation element which is introduced in the introduction direction,

FIG. 8 is a lateral section of a cutout of the embodiment shown in FIGS. 6 and 7 of an adjustable camshaft with a positioning element which is introduced in the introduction direction,

FIG. 9 is a lateral section of a cutout of the embodiment shown in FIGS. 6 to 8 of an adjustable camshaft with a finally positioned inner shaft,

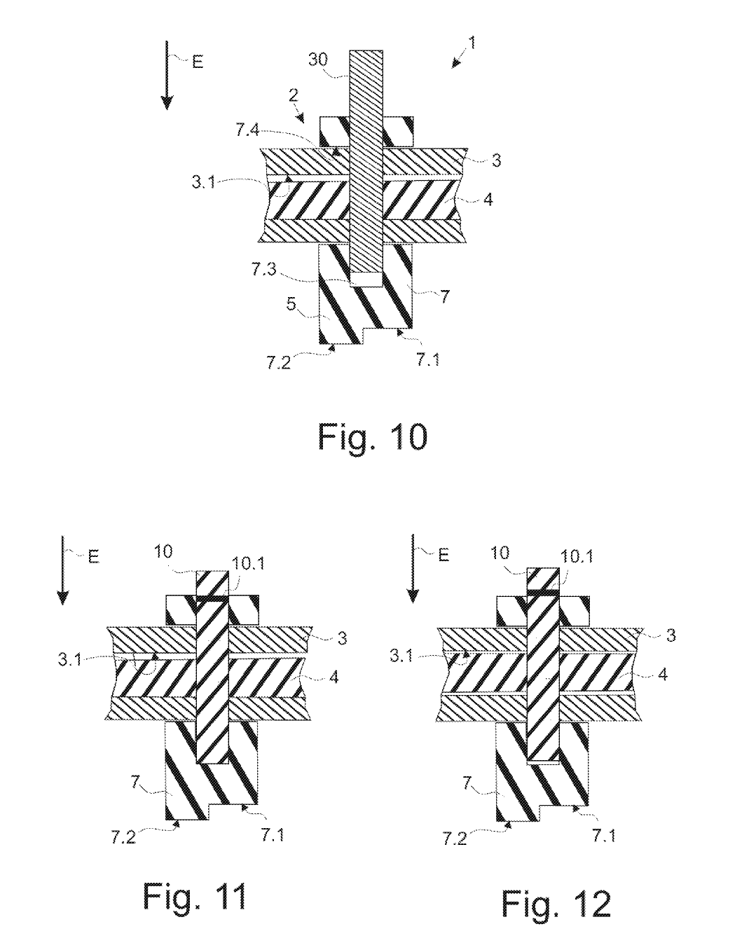

FIG. 10 is a lateral section of a cutout of an additional embodiment of an adjustable camshaft with an orientation element which is introduced in the introduction direction,

FIG. 11 is a lateral section of a cutout of the embodiment shown in FIG. 10 of an adjustable camshaft with a positioning element which is introduced in the introduction direction, and

FIG. 12 is a lateral section of a cutout of the embodiment shown in FIGS. 10 and 11 of an adjustable camshaft with a finally positioned inner shaft.

Elements having the same function and operation are referred to in FIGS. 1 to 12 with the same reference numerals.

FIG. 1 is a cross-section of an embodiment of an adjustable camshaft 1, having an outer shaft 3 and an inner shaft 4 which extends through the through-hole 3.1 of the outer shaft 3. The inner shaft 4 is arranged eccentrically relative to the outer shaft 3, in particular inside the through-hole 3.1 thereof. The inner shaft 4 comprises an inner shaft hole 4.1. The outer shaft 3 comprises a first outer shaft hole 3.2 and a second outer shaft hole 3.3. The embodiment of the adjustable camshaft 1 shown in FIG. 1 further comprises a fixing element 5. The fixing element 5 is advantageously constructed to be annular, in particular in a sleeve-like manner. The outer shaft 3 and the inner shaft 4 extend through the fixing element 5, in particular through a through-hole of the fixing element 5. Advantageously, the fixing element 5, the outer shaft 3 and the inner shaft 4 comprise, after the final assembly has been carried out, a common longitudinal center axis, as shown in particular in FIG. 5 described below. The shaft segment 2 advantageously comprises the outer shaft 3 and the inner shaft 4. The shaft segment 2 or the camshaft 1 is arranged in a device 20 for assembling a camshaft 1 which may also be referred to below as a tool 20.

The embodiment shown in FIG. 1 of a device 20 for assembling an adjustable camshaft 1 comprises a first arrangement segment 21. The first arrangement segment 21 comprises a retention means 21.1 and a recess 21.2. The retention means 21.1 is according to the embodiment shown in FIG. 1 in the form of a recess and corresponds to the geometrical shape of the camshaft 1 so that the camshaft 1 or in particular the fixing element 5 is retained by the retention means 21.1 at least over a peripheral portion. The fixing element 5 comprises a first fixing element hole 5.1 and a second fixing element hole 5.2. The fixing element holes 5.1 and 5.2 are advantageously constructed in alignment with each other. Similarly, the outer shaft holes 3.2 and 3.3 are advantageously constructed in alignment with each other. When the inner shaft 4 is prepositioned inside the through-hole 3.1 in the outer shaft 3, the inner shaft 4 is advantageously arranged in the through-hole 3.1 in such a manner that the inner shaft hole 4.1 extends from one of the outer shaft holes 3.2 or 3.3 to another of the outer shaft holes 3.3 or 3.2 of the outer shaft 3. Advantageously, the fixing element 5 is arranged on the outer shaft 3 in such a manner that one of the fixing element holes 5.1 or 5.2 is orientated congruently relative to one of the outer shaft holes 3.2 or 3.3, respectively. Advantageously, the entire camshaft 1 is inserted in the device 20 or gripped by the device 20 in such a manner that the holes, such as the fixing element holes 5.1 or 5.2, the outer shaft hole 3.2 or 3.3 and the inner shaft hole 4.1, are arranged or orientated in alignment with the recess 21.2 of the device 20 or the first arrangement segment 21 of the device 20.

It is conceivable for the holes, in particular the inner shaft hole 4.1 and/or the outer shaft hole 3.2 or 3.3 and/or the fixing element holes 5.1 or 5.2, to comprise inclined introduction members or chamfers in order to make it easier to introduce an orientation element 30 which is shown in FIG. 2 and/or a positioning element 10 which is shown in FIG. 3 into the camshaft 1 or into the shaft segment 2.

FIG. 2 is a cross-section of the embodiment shown in FIG. 1 of an adjustable camshaft 1 during the introduction of an orientation element 30. The orientation element 30 which is advantageously in the form of a pin element is introduced in an introduction direction E into the shaft segment 2, in particular into the camshaft 1. In this instance, the orientation element 30 is introduced starting from a first fixing element hole 5.1, as shown in FIG. 1, at least through a first outer shaft hole 3.2 of the outer shaft 3 into the inner shaft hole 4.1 of the inner shaft 4. It is further conceivable for the orientation element 30 to be introduced into the shaft segment 2 or the camshaft 1 to such an extent that it also at least partially extends through the second outer shaft hole 3.3 and advantageously also the second fixing element hole 5.2 of the fixing element 5.

FIG. 3 is a cross-section of the embodiment of the adjustable camshaft 1 as shown in FIGS. 1 and 2 during the assembly process of introduction of a positioning element 10. The positioning element 10 is advantageously introduced in the introduction direction E into the camshaft 1 or the shaft segment 2. For this purpose, it is necessary for the orientation element 30 shown in FIG. 2 again to be moved or pulled out of the camshaft 1 or the shaft segment 2. The withdrawal of the orientation element 30 shown in FIG. 2 is advantageously carried out counter to the introduction direction E. The positioning element 10 is advantageously introduced into the camshaft 1 or the shaft segment 2 to such an extent that it contacts the recess 21.2 of the first arrangement segment 21 of the device 20. The recess 21.2 advantageously has a depth which substantially has the magnitude of half of the maximum possible play which exists between the inner shaft and the outer shaft. Consequently, the positioning element 10 is advantageously pushed through the shaft segment 2 or the camshaft 1 to such an extent that it projects out of the shaft segment 2 or the camshaft 1 by the magnitude of half of the maximum possible play.

FIG. 4 is a cross-section of the embodiment of an adjustable camshaft 1 as shown in FIGS. 1 to 3 during the assembly step of the final positioning of the inner shaft 4. For this purpose, the camshaft 1 or the shaft segment 2 is rotated through 180° about the central rotation axis thereof so that the shaft segment 2 or the camshaft 1 can be received in a support segment 23 of the device 20 with the side which corresponds to the side in which the positioning element 10 has been introduced into the camshaft 1 or the shaft segment 2. The support segment 23 is either advantageously an independent element of the device 20 or the tool 20 for assembling an adjustable camshaft 1 or a component of the second arrangement segment 22. The second arrangement segment 22 comprises a contacting means 22.2 and a retention means 22.1. FIG. 4 shows an embodiment of the second arrangement segment 22, in which the retention means 22.1 and the contacting means 22.2 are constructed without any transition in the form of a recess. The recess advantageously comprises a geometrical shaping comparable with the outer periphery of the fixing element 5, in particular the camshaft 1 which comprises the fixing element 5 in order to at least partially contact or surround it. However, it is also conceivable for the retention means 22.1 to be constructed in the form of retention projections, retention webs or comparable retention means while the contacting means 22.2 is constructed, for example, in the form of a projection or a material hardening or surface roughening, etc. It is possible by means of the contacting means 22.2 of the second arrangement element 22 to push back the positioning element 10 counter to the introduction direction E into the shaft segment 2, in particular into the camshaft 1, advantageously by half of the maximum possible play, but in particular by the length with which it projects out of the shaft segment 2, in particular the camshaft 1. For this purpose, the second arrangement segment 22 is applied counter to the introduction direction E to the shaft segment 2, in particular the camshaft 1, in such a manner that the contacting means 22.2 contacts the end of the positioning element 10 projecting out of the shaft segment 2 or the camshaft 1. When a corresponding pressing force is applied, it is possible to push back or move the positioning element 10 counter to the introduction direction E by means of the contacting means 22.2 of the second arrangement segment 22.

FIG. 5 shows the final positioning of the inner shaft 4 inside the through-hole 3.1 of the outer shaft 3. In this instance, the inner shaft 4 is arranged concentrically relative to the outer shaft 3 and advantageously also concentrically relative to the fixing element 5. The positioning element 10 is advantageously arranged completely inside the camshaft 1. Consequently, the positioning element 10 advantageously does not project out of the shaft segment 2 or the camshaft 1 at any of the sides any longer.

FIG. 6 is a lateral section of a cutout of an additional embodiment of an adjustable camshaft 1. The adjustable camshaft 1 comprises, in addition to the outer shaft 3 and the inner shaft 4, a fixing element 5 in the form of a collared cam 6 or a collared cam element 6. The collared cam element 6 comprises a cam collar 6.1 and two cam paths, that is to say, a first cam path 6.2 and a second cam path 6.3. A collared cam hole 6.4 extends through the cam collar 6.1. Advantageously, the collared cam hole 6.4 is arranged in alignment with the outer shaft hole which is not illustrated here during the operation of prepositioning the inner shaft 4. In the assembly step shown in FIG. 6, an orientation element 30 is introduced counter to the introduction direction E in the movement direction B into the camshaft 1. In this case, the orientation element 30 extends through the collared cam element 6 and the shaft segment 2 of the camshaft 1 extends through the holes of the individual elements or segments which are advantageously orientated in alignment with each other.

As shown in FIG. 7, it is also conceivable for the orientation element 30 to be moved in a movement direction B which corresponds to the introduction direction E. This means that the orientation element 30 is pushed or introduced in the introduction direction E into the camshaft 1 and in particular into the shaft segment 2 of the camshaft 1 through the corresponding holes in order to allow an orientation of the fixing element 5 or the fixing element 5 in the form of a collared cam element 6 relative to the outer shaft 3 and the inner shaft 4. Advantageously, the embodiment of the cam element 1 of FIG. 7 corresponds to the embodiment of the camshaft 1 shown in FIG. 6 so that reference may be made to the description of FIG. 6 with regard to the configuration of the camshaft 1.

FIG. 8 is a lateral section of a cutout of the embodiment shown in FIGS. 6 and 7 of an adjustable camshaft 1. In FIG. 8, instead of an orientation element 30, a positioning element 10 is introduced into the holes of the camshaft 1, in particular the holes of the collared cam elements 6, the outer shaft 3 and the inner shaft 4. The positioning element 10 has advantageously been pushed through the holes of the camshaft 1 in the introduction direction E to such an extent that it extends or projects out of the camshaft 1 at least at one side thereof. The inner shaft 4 is further arranged eccentrically relative to the outer shaft 3 in this method step for assembling an adjustable camshaft 1. The positioning of the inner shaft 4 is carried out in an additional subsequent assembly step, in which the inner shaft 4 is orientated concentrically relative to the outer shaft 3. This is particularly illustrated in FIG. 9.

According to the illustration of FIG. 9, the positioning element 10 has been moved back counter to the introduction direction E by the amount by which the positioning element 10 projects out of the camshaft 1. Advantageously, this corresponds to the magnitude of half of the maximum possible play. By the positioning element 10 being moved back counter to the introduction direction E, as a result of the existing static friction force between the outer surface of the positioning element 10 which is advantageously constructed as a pin element and the surface of the inner shaft hole 4.1 (not shown) of the inner shaft 4, a joint movement of the inner shaft 4 counter to the introduction direction E is also allowed advantageously by half of the maximum possible play. After the final positioning of the inner shaft 4 has been carried out within the outer shaft 3, the positioning element 10 is advantageously also located inside the shaft segment 10 or inside the camshaft 1 in such a manner that it does not project or protrude at any of the sides.

FIGS. 10 to 12 are lateral sections of a cutout of an additional embodiment of an adjustable camshaft 1. The adjustable camshaft 1 does not comprise, unlike the embodiment shown in FIGS. 6 to 9 of an adjustable camshaft 1, any collared cam element 6 but instead a simple cam element 7 which is consequently used inter alia as a fixing element 5. The cam element 7 comprises a first cam path 7.1 and a second cam path 7.2. A cam element hole 7.3 extends at least partially in the cam element 7. FIG. 10 shows in a first assembly step for producing an adjustable camshaft 1 the introduction of an orientation element 30 which extends through the cam element hole 7.3 and the outer shaft hole 3.2 and 3.3 (not shown here) and the inner shaft hole 4.1 (not shown here). The movement direction B of the orientation element 30 corresponds in this instance to the introduction direction E. Advantageously the orientation element 30 extends through all the holes of the camshaft 1 in order to allow the cam element 7 to be orientated relative to the outer shaft 3 and relative to the inner shaft 4 or the individual elements to be orientated relative to each other. After the orientation element 30 has been moved counter to the introduction direction E out of the cam element 1, a positioning element 10 is introduced in an introduction direction E into the holes of the cam element 7, the outer shaft 3 and the inner shaft 4 in an introduction direction E, which holes are orientated in a mutually aligned manner. This is shown in particular in FIG. 11. Advantageously, the positioning element 10 is at least partially pushed in this instance through the shaft segment 2 into the cam element hole 7.3. Advantageously, the positioning element 10 is pushed as far into the cam element hole 7.3 until a first distal end 10.1 of the positioning element 10 contacts an end wall of the cam element hole 7.3 which is in the form of a blind hole.

For the final positioning of the inner shaft 4, as shown in FIG. 12, the positioning element 10 is moved counter to the introduction direction E, advantageously by the magnitude of half of the maximum possible play, so that the inner shaft 4 is also moved counter to the introduction direction E as a result of the static friction force which exists between the outer surface of the positioning element 10 and the surface of the inner shaft hole of the inner shaft 4. As shown in FIG. 12, a second distal end 10.2 of the positioning element 10 is located outside the camshaft 1 and consequently projects out of the camshaft 1. A desired breaking location 11 is used to remove this projecting positioning element piece. By means of this desired breaking location, the removal of the projecting distal end 10.2 of the positioning element 10 is advantageously facilitated. Advantageously, the desired breaking location 11 is also used to characterize the positioning element 10 with regard to the portion or region of the positioning element 10 which is intended to be pulled out of the camshaft 1 or the shaft segment 2. This means that the desired breaking location 11 is also used as a marking.

### LIST OF REFERENCE NUMERALS

1 Camshaft
2 Shaft segment
3 Outer shaft
3.1 Through-hole of the outer shaft
3.2 (First) outer shaft hole
3.3 (Second) outer shaft hole
4 Inner shaft
4.1 Inner shaft hole
5 Fixing element
5.1 (First) fixing element hole
5.2 (Second) fixing element hole
6 Collared cam element
6.1 Cam collar
6.2 First cam path
6.3 Second cam path
6.4 Collared cam hole
7 Cam element
7.1 First cam path
7.2 Second cam path
7.3 Cam element hole
10 Positioning element
10.1 First distal end of the positioning element
10.2 Second distal end of the positioning element
20 Device/tool
21 First arrangement segment
21.1 Retention means
21.2 Recess
22 Second arrangement segment
22.1 Retention means
22.2 Contacting means
23 Support segment
B Movement direction
E Introduction direction

1.-11. (canceled)

12. A method for assembling an adjustable camshaft that includes a shaft segment with an outer shaft and an inner shaft that extends concentrically through a through-hole of the outer shaft, the method comprising:
prepositioning the inner shaft such that the inner shaft is at least partially introduced eccentrically into the through-hole of the outer shaft;
introducing a positioning element in an introduction direction through a first outer shaft hole formed in a peripheral wall of the outer shaft, through an inner shaft hole that extends orthogonally to a longitudinal axis of the inner shaft, and through a second outer shaft hole formed in the peripheral wall of the outer shaft, such that the positioning element projects out of the second outer shaft hole; and
finally positioning the inner shaft, wherein the positioning element is moved counter to the introduction direction such that the inner shaft is oriented concentrically inside the through-hole of the outer shaft.

13. The method of claim 12 comprising pushing the positioning element out of the shaft segment at least by a magnitude of half of a maximum possible play in the introduction direction.

14. The method of claim 12 comprising moving the positioning element into the shaft segment by less than a magnitude of half of a maximum possible play counter to the introduction direction.

15. The method of claim 12 comprising moving the positioning element into the shaft segment by more than a magnitude of half of a maximum possible play counter to the introduction direction.

16. The method of claim 12 comprising moving the positioning element into the shaft segment by a magnitude of half of a maximum possible play counter to the introduction direction.

17. The method of claim 12 comprising introducing an orientation element before introducing the positioning element, wherein the orientation element is introduced in the introduction direction at least through the first outer shaft hole and the inner shaft hole at least for an orientation of the first outer shaft hole relative to the inner shaft hole.

18. The method of claim 17 comprising introducing the orientation element at least partially into the second outer shaft hole.

19. The method of claim 17 comprising moving the orientation element counter to the introduction direction out of the shaft segment.

20. The method of claim 20 comprising moving the orientation element in the introduction direction out of the shaft segment.

21. The method of claim 12 comprising introducing an orientation element before introducing the positioning element, wherein the orientation element is introduced counter to the introduction direction at least through the second outer shaft hole and the inner shaft hole at least for an orientation of the second outer shaft hole relative to the inner shaft hole.

22. The method of claim 21 comprising introducing the orientation element at least partially into the first outer shaft hole.

23. The method of claim 21 comprising moving the orientation element counter to the introduction direction out of the shaft segment.

24. The method of claim 21 comprising moving the orientation element in the introduction direction out of the shaft segment.

25. The method of claim 12 comprising positioning a fixing element on the outer shaft such that a fixing element hole that extends through a peripheral wall of the fixing element is aligned with at least one of the first outer shaft hole or the second outer shaft hole.

26. A device for assembling an adjustable camshaft having a shaft segment that comprises an outer shaft and an inner shaft that extends concentrically through a through-hole of the outer shaft, the device comprising:
a first arrangement segment for prepositioning the inner shaft inside the through-hole of the outer shaft such that the inner shaft is positioned eccentrically relative to the outer shaft, wherein the first arrangement segment comprises a recess for receiving a portion of a positioning element projecting at least out of the shaft segment, wherein the positioning element is at least partially introduced through the shaft segment; and
a second arrangement segment for finally positioning the inner shaft inside the through-hole of the outer shaft such that the inner shaft is positioned concentrically relative to the outer shaft, wherein the second arrangement segment comprises a contacting means for introducing the positioning element at least into the shaft segment,
wherein each of the first and second arrangement segments comprises a retention means that positions the outer shaft or a fixing element that is positionable on the outer shaft.
